(19) United States
(12) Patent Application Publication
(10) Pub. No.: US 2024/0238742 A1
(43) Pub. Date: Jul. 18, 2024

(54) COMPACT CENTRIFUGAL MIXING DEVICE AND METHODS OF USE THEREOF

(71) Applicant: FLACKTEK SPEEDMIXER, INC., LANDRUM, SC (US)

(72) Inventors: Dale R. FLACKETT, LANDRUM, SC (US); Matthew L. GROSS, BOULDER, CO (US); Kristopher C. HALL, MARYVILLE, TN (US); Benjamin D. NIBALI, MARYVILLE, TN (US); Gary L. MITCHELL, KNOXVILLE, TN (US)

(21) Appl. No.: 18/291,686

(22) PCT Filed: Aug. 17, 2022
(86) PCT No.: PCT/US2022/040630

§ 371 Date: Jan. 24, 2024

Related U.S. Application Data
(60) Provisional application No. 63/234,007, filed on Aug. 17, 2021.

(51) Int. Cl. B01F 29/10; B01F 29/00

(52) U.S. Cl. CPC B01F 29/10; B01F 29/40351

(57) ABSTRACT

Devices, systems, and methods are provided for mixing a compact dual axis centrifugal mixer configured to rotate a receptacle containing a voluminous substance to be mixed about two different axes. The compact dual axis centrifugal mixer may be configured to function as a tabletop mixer. The dual axis centrifugal mixing device of the invention may further include power transmission system adapted to transmit rotational energy produced by a rotary motor to a second rotatable housing allowing synchronous or asynchronous rotation of the second rotatable housing in relation to a first rotatable housing.

### CROSS-REFERENCE TO RELATED APPLICATIONS

This International PCT Application claims the benefit of and priority to U.S. Provisional Application No. 63/234,007, filed Aug. 17, 2021, which is incorporated herein by reference in its entirety.

### TECHNICAL FIELD

The present invention is directed to a mixing system, and in particular an improved compact dual axis centrifugal mixing device and methods of use thereof.

### BACKGROUND

Flowable materials are often a mixture of several components. It can be desirable to mechanically mix the components thoroughly and completely at high speeds to provide homogeneity of the resultant mixture. The mixing process can be particularly important for materials which are challenging to handle such as fine or highly viscous materials. Asymmetric rotation of the components in a mechanical mixer can provide the appropriate mixing for the desired mixing results.

Yet, conventional asymmetric rotation mixers can present challenges to scaled process operations. For example, conventional asymmetric rotation mixers are typically not compatible for custom, small-batch, or point-of-sale mixing applications. For example, traditional conventional asymmetric rotation mixing systems are generally neither appropriate, nor cost-effective for customized mixed products prepared “on-demand” for individual consumers, preferably in a commercial or retail setting.

As such, there exists a long-felt need for a compact centrifugal mixing device that is both cost-effective and compatible with small batch production of customized products that can be operated by retail or other point-of-sale operators with little training.

### SUMMARY OF THE INVENTION

In one aspect, the invention include systems methods and devices for a compact dual axis centrifugal mixing device. In one preferred aspect, the dual axis centrifugal mixing device of the invention includes a rotary motor coupled with a drive shaft adapted to rotate on a first rotational axis (X). This drive shaft may further be coupled to a first rotatable housing and adapted to rotate about the first rotational axis (X). The dual axis centrifugal mixing device of the invention may further include a second rotatable housing coupled with the first rotational housing. This second rotatable housing is responsive to a power transmission system that is coupled to the drive shaft of the invention and adapted to rotate about a second rotational axis (Y). In this embodiment, a receptacle can be secured by the second rotatable housing and further rotated about the second rotational axis (Y).

In another aspect, the dual axis centrifugal mixing device of the invention includes first rotatable housing having a concave upper surface and an opening between the first rotational axis and the upper edge of said first rotatable housing. The opening of the invention is adapted to receive a receptacle and allow it to be secured by the second rotatable housing in an approximately horizontal position.

In another aspect, the dual axis centrifugal mixing device of the invention includes power transmission system adapted to allow synchronous or asynchronous rotation of the first and second rotatable housings of the invention. In a preferred aspect, the power transmission system is adapted to transmit the rotational energy produced by the rotary motor to the second rotatable housing allowing synchronous or asynchronous rotation of the second rotatable housing in relation to the first rotatable housing that is responsive, in this embodiment to a drive shaft of the invention.

In another aspect, the power transmission system of the invention includes a belt routing system. In this preferred aspect, the belt routing system includes a belt, or other similar apparatus that transmits rotational energy to drive the rotation of the second rotatable housing. that is responsive to a drive shaft through a gear wheel. Rotation of the gear wheel causes the belt of the invention to transit across one or a plurality of primary and/or secondary pullies and rotate the second rotatable housing. In a preferred aspect, depending on the configuration of the power transmission system, the direction of rotation of the first and second rotatable housings can be synchronous or asynchronous, while the relative angle between the first and second rotational axes of each housing is substantially constant during operation of the device.

Additional aspects of the invention may become evident based on the specification and figures presented below.

### BRIEF DESCRIPTION OF THE FIGURES

FIGS. 1A-C: (A) shows a perspective view of a compact dual axis centrifugal mixer having a first and second rotatable housing positioned within a stationary housing in one embodiment thereof; (B) shows a perspective view of a compact dual axis centrifugal mixer having a first and second rotatable housing positioned within a stationary housing and a secured lid apparatus in one embodiment thereof; and (C) is a cross-sectional view of a shows a perspective view of a compact dual axis centrifugal mixer having a first and second rotatable housing positioned within a stationary housing and coupled with a drive shaft and belt routing system in one embodiment thereof;

FIGS. 2A-C: (A) shows an a top and perspective isolated view of a rotary motor coupled with a drive shaft that is further responsive to a belt routing system having a gear wheel, a belt and a paired series of primary pullies that drives the rotation of a second rotational housing securing a receptacle in one embodiment thereof; (B) shows an isolated view of a first and second rotatable housing responsive to a rotatory motor in one embodiment thereof; (C) shown two isolated view of a first and second rotatable housing, with the first rotational housing having a concave upper surface and an opening to accommodate a receptacle secured in the second rotational housing and a counter weight opposite the receptacle in one embodiment thereof.

FIG. 3: shows an isolated view of a receptacle positioned within a second rotatable housing that is coupled with a belt routing system including a gearwheel securing a belt that is responsive to a paired series of primary and secondary pullies in one embodiment thereof.

FIG. 4: shows an isolated view of a first and second rotatable housing that is coupled with a belt routing system including a gearwheel securing a belt that is responsive to a paired series of primary and secondary pullies in one embodiment thereof.

FIG. 5: (above) shows an isolated view of a paired series of primary and secondary pullies in relation to a second rotatable housing, (below) shows a vacuum housing positioned over a first and second rotatable housing coupled with a rotary motor.

FIG. 6: shows a front view of a first rotational housing having a concave upper surface and an opening to accommodate a receptacle secured in the second rotational housing.

FIG. 7: shows a perspective view of a first rotational housing having a concave upper surface and an opening to accommodate a receptacle secured in the second rotational housing.

### DETAILED DESCRIPTION OF THE INVENTION

The present invention includes a variety of aspects, which may be combined in a variety of different ways. The following descriptions are provided to list elements and describe certain preferred embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

According to various example embodiments of the present general inventive concept, a compact dual axis centrifugal mixer (1), sometimes referred to as a dual axis mixer or device, is provided that is configured to rotate a receptacle (2), or a plurality of receptacles, containing a voluminous substance to be mixed, about two different axes shown herein as the X and Y axes, with a single motor drive shaft (3) to mix the substance. In an example embodiment, the compact mixer (1) may be configured to function as a tabletop mixer.

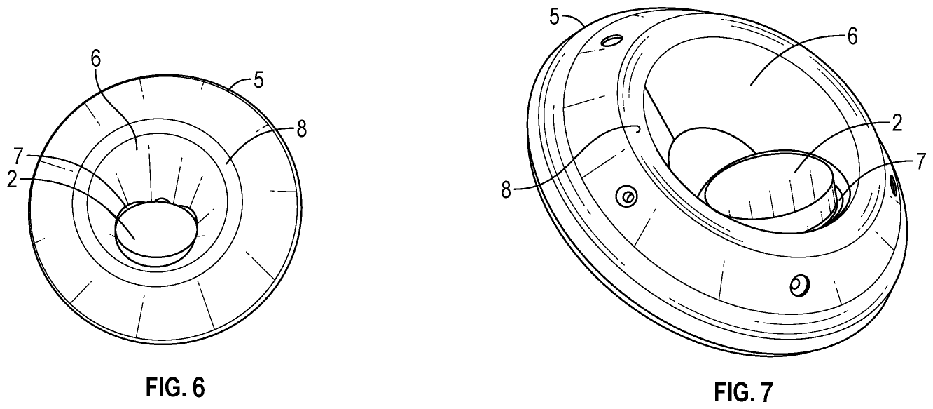

In various example embodiments, a dual motor mixer may be utilized rather than a single motor drive, and may provide advantages over the single motor concept with a mechanically linked secondary axis. In various example embodiments, the container is rotated at an angle about a rotational axis (X) of the drive shaft, while the container is also rotated about its own longitudinal axis (Y). The Y-axis about which the receptacle is rotated (which may be referred to as a second or secondary axis) is substantially vertical, and the X-axis about which the drive shaft rotates (which may be referred to as a first or primary axis) is substantially tilted relative to the secondary axis (Y). Various example embodiments that utilize a plurality of receptacles (2), such as cups or other receptacles commonly used in centrifugal mixing application, may aid in balancing the rotating mass. As shown in FIGS. 6-7, one benefit of a single receptacle system is that the axis of the receptacle (Y) can be conveniently positioned approximately vertically when loading and unloading the receptacle (2). With a multi-receptacle arrangement, the other receptacles may be tilted during the loading and unloading process.

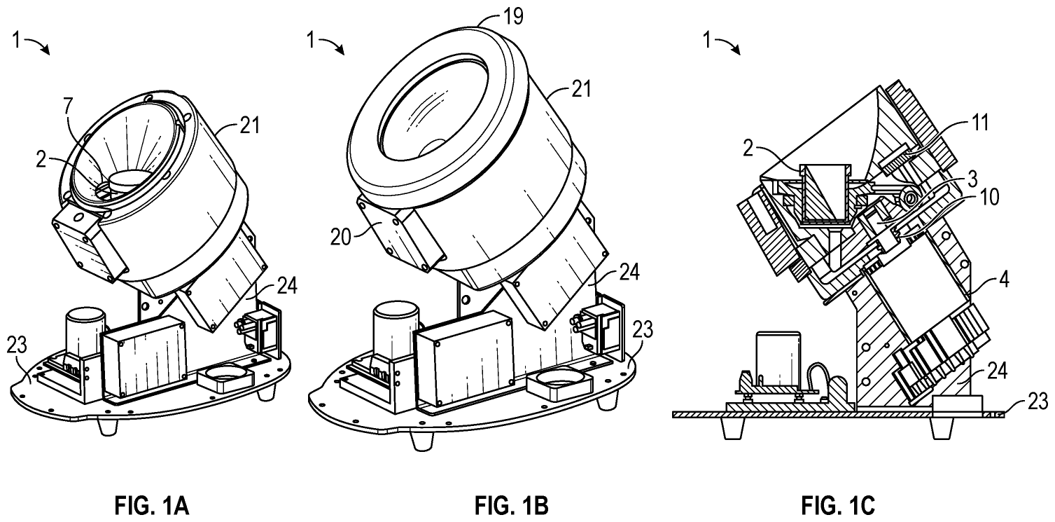

FIG. 1 illustrates perspective views and a cross section of a dual axis mixer (1), without various portions of the body and/or other elements, according to an example embodiment of the present general inventive concept. As illustrated, various components of the dual axis mixer (1), including mechanical moving components and control electronics, have been miniaturized to fit into a compact model that is also conveniently portable. As illustrated in the cross section portion of FIG. 1, a rotary motor (4) is arranged in the mixer (1) at an acute angle (X) relative to a vertical axis (Z), and is configured to rotate a first rotatable housing (5) rotatable housing (5) by the drive shaft (3) extending from the rotary motor. The first rotatable housing (5), which has an axis of rotation (X) centered on the primary drive shaft (3), referred to herein as the first rotational axis, has a concave upper surface (6) with an opening (7) between the rotational axis (X) and the upper edge (8) of the first rotatable housing (5). This opening allows access to a second rotatable housing (9) that is configured to receive a receptacle (2) containing the substance to be mixed therein.

The second rotatable housing (9) is configured to rotate about its longitudinal axis, referred to herein as the second rotational axis or Y-axis, which is arranged at a substantially vertical angle relative to the first rotational axis. When the receptacle (2) is inserted into the second rotatable housing (9), and the mixer (1) is turned on, the first rotatable housing (5) spins about the first rotational axis (X), while the second rotatable housing (9) spins about the second rotational axis (Y). The center of mass of the first rotatable housing (5) may be set near the mid-plane/radial-plane of the first rotatable housing bearing (10), which allows for forces due to load imbalance to be directed into the bearings inner race at the radial plane instead of creating a moment by offsetting the load away from the inner race.

In various example embodiments a counterweight (11) may be provided inside the first, or primary, rotatable housing (5), and adjusted to reduce vibration of the unit when spinning. This adjustment is done by spinning the first rotatable housing (5) on a horizontal axis with low friction bearings. As the rotation comes to a stop, the housing (5) is checked for a bias in the stop point, or for a tendency for slight rotation in the opposite direction. This may be repeated a plurality of times with various counterweights until a minimally biased arrangement is determined.

In various example embodiments, the rotary motor (4) includes a servo motor that may further be provided with an autotune function, examples of which would be known to those of ordinary skill in the art. Running the autotune function may allow for smoother operation by varying acceleration and deceleration values based on the mass and imbalance detected during the autotune function. Various examples of the dual axis mixer (1) may be configured to operate at approximately 3,000 rpm, but, mechanically, may be capable of spinning faster (˜10,000 rpm and above). Various example embodiments may employ a coupling system between the motor and mixing system to reduce wear and excessive loads on the motor.

The direction of rotation of the first and second rotatable housing (5,9) may be the same (synchronous) or opposite (asynchronous), depending on the type of power transmission linking the two axes together. The relative rotation direction could be reversed without mechanical change in a dual motor system. The relative angle between the two axes of rotation (X, Y) remain substantially constant. In this configuration, the cross-sectional attitude of the voluminous substance contained in the receptacle is substantially maintained during rotation compared to prior art mixers, reducing air displacement of the substance during the mixing operation.

The shape of the mass spinning on the primary axis is unique, and the substantially constant cross section allows for higher speeds and quieter operation. The double angle configuration (with the secondary angle being substantially vertical) also provides a substantially upright or straight start and stop position, facilitating ease of installation and removal of the receptacle (2) and reducing opportunity for spillage of the substance during installation, mixing, and removal.

In one embodiment, the dual axis centrifugal mixing device (1) of the invention includes power transmission system adapted to allow synchronous or asynchronous rotation of the first and second rotatable housings (5, 9) about their respective axis in an independent synchronous or asynchronous manner. As describe herein, a power transmission system describes a mechanical system adapted to transmit the rotational force generate by a rotary motor (4) to the second rotatable housing (9) allowing synchronous or asynchronous rotation of the second rotatable housing (9) in relation to the first rotatable housing (5).

In a prefer aspect detailed below, the power transmission system of the invention includes a belt routing system (13). In this preferred embodiment, the belt routing system (13) includes a belt (13), or other similar apparatus that transmits rotational energy, preferably generated by a rotary motor (4), to drive the rotation of the second rotatable housing (9). In this embodiment, a rotary motor (4) may generate rotational force that is transmitted to a drive shaft (3) coupled with a gear wheel (14) responsive to a belt (15). Rotation of the gear wheel (14) causes the belt (15) of the invention to transit across one or a plurality of primary and/or secondary pullies (16, 17) and transmitting the rotational force generated by the motor (3) to the second rotatable housing (9). In a preferred aspect, depending on the configuration of the power transmission system, the direction of rotation of the first and second rotatable housings (5, 9) can be synchronous or asynchronous, while the relative angle between the first and second rotational axes (X, Y) of each housing is substantially constant during operation of the device. Various other example embodiments may utilize power transmission through, a power transmission system, for example, gear or rack & pinion, chain drives, secondary motors, magnetic drives, pneumatic drives, friction contact, and the like.

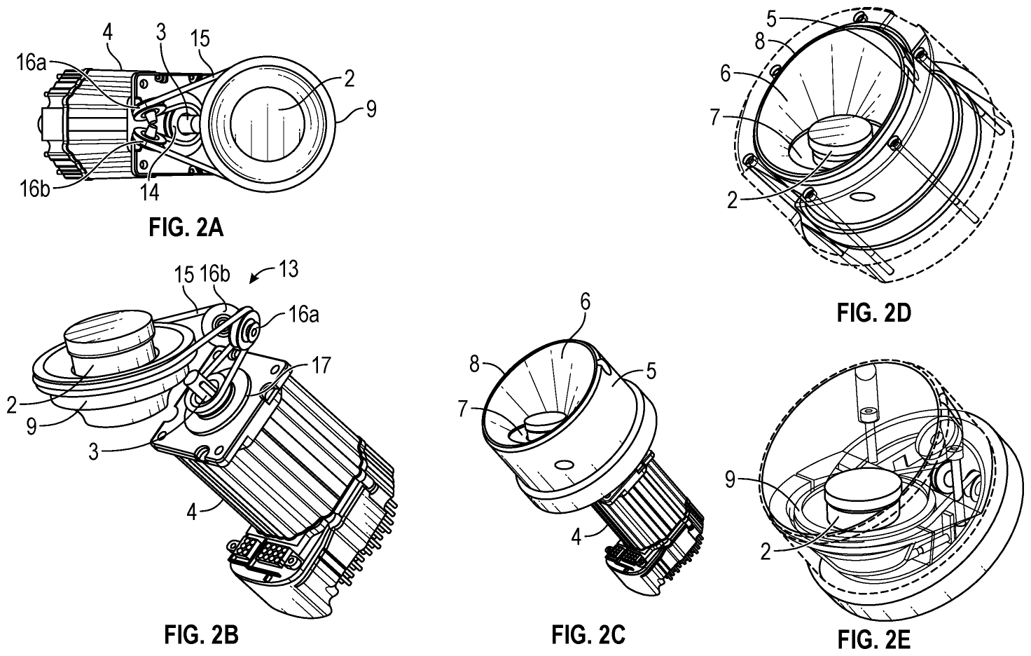

FIG. 2 illustrates multiple views of the belt routing system (13) of the invention, also sometimes referred to as the belt router, which actuates dual axis rotational driving by a single rotary motor (4) according to an example embodiment of the present general inventive concept. As illustrated in FIG. 2, the drive shaft (3) that rotates the first rotatable housing (5) is provided with a belt drive gear, sometime referred to as a gear wheel (14) that is centered on the drive shaft (3). As shown, the corresponding belt (15) of the belt routing system (13) of the invention is used to transfer the rotational power to the second rotatable housing (5). The belt (15) is looped around the gear wheel (14), about two pulleys (16a, 16b) arranged substantially opposite the second rotational axis from the second rotatable housing (9), and about an outer diameter of the first rotatable housing (5). With the arrangement of this example embodiment, when the drive shaft (3) and first rotatable housing (5) are rotated in a clockwise direction, the second rotatable housing (9) is rotated in a counterclockwise direction. In various example embodiments the relative RPM's of the two bodies may be adjustable varying sizes of the gear wheel, sizes and/or positioning of the pulleys, and the like.

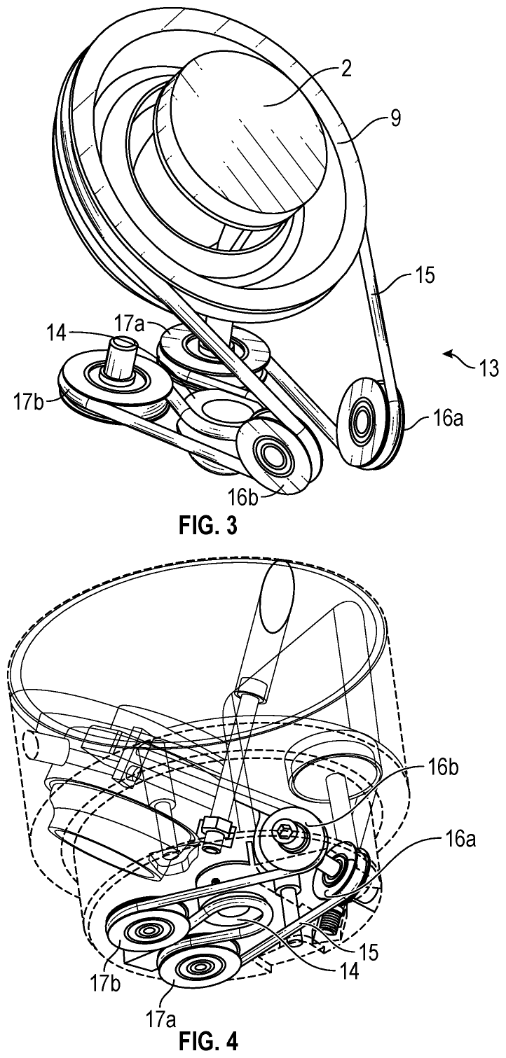

FIGS. 3-4 illustrate a different pulley arrangement according to another example embodiment of the present general inventive concept. In the example embodiment illustrated in FIGS. 3-4, the arrangement of an additional secondary pulleys (17a, 17b) provided on the same side of the axis of rotation as the second rotatable housing (9) cause the second rotatable housing (9) to be rotated in a clockwise direction when the drive shaft (3) and the first rotatable housing (5) are rotated in a clockwise direction. The rotational speed and/or direction of the rotary motor (4) may be controlled by the system controller (18), and such controls may be selected through a graphical user interface provided on the casing of the mixer. It is understood that such a belt driven system and configuration is simply one example embodiment of power transmission to the secondary axis. Various other example embodiments may utilize power transmission through, a power transmission system, for example, gear or rack & pinion, chain drives, secondary motors, magnetic drives, pneumatic drives, friction contact, and the like.

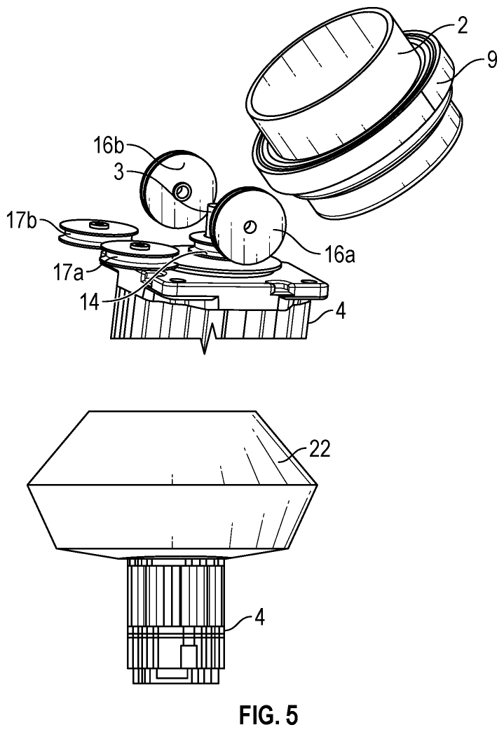

As shown in FIG. 1, in a preferred embodiment the first and second rotational housings (5, 9) may be positioned within a stationary housing (21) that may further be supported by an internal bracket (24) coupled with a support (23) and covered by an external shell (not shown). In this configuration, the stationary housing (21) may include a lid (19) that can be positioned over the upper surface of the first rotational housing (5) and secured by a lock (20) to allow safer operation of the device. In certain embodiments it may be desirable to operate the device in a vacuum environment to assist in the mixing of certain flowable materials and prevent entrapment of air in the material. As shown in FIG. 5, a the upper portion of the device, including the first and second rotational housings (5, 9) and stationary housing (21) may further be positioned within a vacuum chamber (22) that can be adapted to create a low pressure or complete vacuum environment.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

The following detailed description is provided to assist the reader in a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90° degrees or at other orientations) and the spatially relative descriptors used herein interpreted accordingly.

1. A dual axis centrifugal mixing device comprising:
a rotary motor coupled with a drive shaft adapted to rotate on a first rotational axis (X);
a first rotatable housing coupled to said drive shaft that rotates about said first rotational axis (X);
a second rotatable housing coupled with said first rotational housing, wherein said second rotatable housing is responsive to a power transmission system that is coupled to said drive shaft and rotates said second rotatable housing about a second rotational axis (Y); and
a receptacle secured by said second rotatable housing and rotated about said second rotational axis (Y);
wherein said second rotational axis is substantially vertical relative to a vertical axis (Z), and wherein said first rotational axis is angled relative to said second rotational axis.

2. The device of claim 1, wherein said first rotatable housing comprises a concave upper surface.

3. The device of claim 2, wherein said concave upper surface comprises an opening between the first rotational axis and the upper edge of said first rotatable housing.

4. The device of claim 3, wherein said opening is adapted to receive said receptacle in an approximately horizontal position.

5. The device of claim 1, further comprising a counterweight positioned within said first rotational housing.

6-8. (canceled)

9. The device of claim 1, wherein said power transmission system comprises a belt routing system.

10. The device of claim 9, wherein said belt routing system comprises:
a gear wheel that rotates in response to the rotation of said drive shaft;
a belt responsive to the rotation of said gear wheel; and
a series of primary pullies positioned opposite said second rotational axis, and responsive to the movement of said belt and said second rotatable housing, wherein the rotational force generated by said drive shaft is transmitted to said second rotatable housing causing it to rotate.

11. The device of claim 10, wherein said belt routing system further comprises:
a series of secondary pullies responsive to said gear wheel and said series of primary pullies by the movement of said belt, wherein said series of secondary pullies are positioned on the same side of the second axis of rotation as said second rotatable housing and opposite from said series of primary pullies, wherein the rotational force generated by said drive shaft is transmitted to said second rotatable housing causing it to rotate.

12. The device of claim 1, wherein the direction of rotation of the first and second rotatable housings is asynchronous.

13. The device of claim 1, wherein the direction of rotation of the first and second rotatable housings is synchronous.

14-15. (canceled)

16. The device of claim 1, relative angle between the first and second rotational axes is substantially constant during operation of the device.

17-32. (canceled)

33. A housing for a dual axis centrifugal mixing device comprising:
a first rotatable housing that rotates about said first rotational axis (X) having:
a concave upper surface;
an opening between the first rotational axis and the upper edge of said first rotatable housing;
a second rotatable housing coupled with said first rotational housing, wherein said second rotatable housing rotates about a second rotational axis (Y); and
a receptacle positioned within said opening and secured by said second rotatable housing and rotated about said second rotational axis (Y), wherein said opening is adapted to receive said receptacle in an approximately horizontal position.

34. The housing of claim 33, wherein said first rotatable housing is coupled to a drive shaft, responsive to a rotary motor, that rotates about said first rotational axis (X).

35. (canceled)

36. The housing of claim 33, wherein said second rotatable housing is responsive to a power transmission system that rotates said second rotatable housing about a second rotational axis (Y).

37. The device of claim 36, wherein said power transmission system comprises a belt routing system.

38. The device of claim 37, wherein said belt routing system comprises:
a gear wheel that rotates in response to the rotation of said drive shaft;
a belt responsive to the rotation of said gear wheel; and
a series of primary pullies positioned opposite said second rotational axis, and responsive to the movement of said belt and said second rotatable housing, wherein the rotational force generated by said drive shaft is transmitted to said second rotatable housing causing it to rotate.

39. The device of claim 38, wherein said belt routing system further comprises:
a series of secondary pullies responsive to said gear wheel and said series of primary pullies by the movement of said belt, wherein said series of secondary pullies are positioned on the same side of the second axis of rotation as said second rotatable housing and opposite from said series of primary pullies, wherein the rotational force generated by said drive shaft is transmitted to said second rotatable housing causing it to rotate.

40. (canceled)

41. The device of claim 33, wherein the direction of rotation of the first and second rotatable housings is asynchronous.

42. The device of claim 33, wherein the direction of rotation of the first and second rotatable housings is synchronous.

43. The device of claim 33, wherein said second rotational axis is substantially vertical relative to a vertical axis (Z).

44. The device of claim 43, wherein said first rotational axis is angled relative to said second rotational axis.

45. The device of claim 33, wherein the relative angle between the first and second rotational axes is substantially constant during operation of the device.

46. (canceled)
